(19) United States
(12) Patent Application Publication
(10) Pub. No.: US 2026/0135055 A1
(43) Pub. Date: May 14, 2026

(54) ELECTRICAL DEVICE WITH MOVABLE HARDSTOP

(71) Applicant: Sensata Technologies, Inc., Attleboro, MA (US)

(72) Inventors: Wyles Griffin Vance, Carpinteria, CA (US); Guillermo Munguia Lozano, Ventura, CA (US)

(73) Assignee: Sensata Technologies, Inc., Attleboro, MA (US)

(21) Appl. No.: 18/941,787

(22) Filed: Nov. 8, 2024

(51) Int. Cl. H01H 71/12; H01H 71/24; H01H 71/50

(52) U.S. Cl. CPC H01H 71/122; H01H 71/2445; H01H 71/2463; H01H 71/505; H01H 2235/004

(57) ABSTRACT

A contactor device includes a movable contact configured to selectively open/close an electrical circuit. The movable contact is coupled to a shaft, and the shaft is retained by a latch in the closed position. A movable member is biased away from the latch. During an event, the biasing force biasing the movable member away from the latch is overcome. The movable member causes the latch to disengage the shaft, allowing the shaft to move to an open position. In examples, the movable member is disposed over an opening in a housing of the contactor device.

### FIELD OF THE TECHNOLOGY

The subject disclosure relates to electrical switching devices, such as electrical fuse devices, and more particularly to improved passive and/or active fuse devices with a movable hardstop.

### BACKGROUND OF TECHNOLOGY

Many conventional devices are known to selectively power on or off electrical devices. Electrical contactors, e.g., high-voltage DC contactors, and fuses, e.g., electrical fuses and/or pyrotechnic fuses, are conventionally available and used in electrical systems. Contactors may be configured to interrupt or complete a circuit to control electrical power to and/or from a device.

In many conventional systems, a fuse is configured as a type of switch, e.g., to selectively allow/disallow current flow. In some examples, a fuse includes a movable contact coupled to a shaft. In a normally-closed fuse, the shaft may be normally positioned such that the movable contact is in contact with one or more fixed contacts. In these examples, the shaft (and the movable contact(s)) may be biased away from the fixed contact(s), e.g., to “open” the fuse and prevent current flow through the contactor. For example, a return spring may bias the shaft to an open position. Thus, in the closed configuration, the movable contact is held against the biasing force of the return spring.

In some conventional examples, the shaft and/or the movable contact may be held against the biasing force of the spring by a mechanical feature. In these examples, during an event, such as a surge, an overcurrent event, a short, or the like, the mechanical feature may be reconfigured, e.g., moved or destroyed, to cease holding the shaft/movable contact. However, in these conventional fuse devices, the actuation of the mechanical feature can be unreliable, may be relatively costly to manufacture, and/or may suffer from other shortcomings.

Accordingly, there is a need in the art for improved fuse devices and methods of making and assembling those devices. There also is a need in the art for improved devices with increased reliability and/or reduced complexity and/or cost.

### SUMMARY OF THE TECHNOLOGY

The subject technology relates to improved electrical devices and methods of making and using those devices. In examples, aspects of this disclosure relate to improved fuse devices with features for reliably opening a circuit via passive (e.g., on-device) and/or active (e.g., remote) triggering. For example, aspects of this disclosure can relate to features and/or systems that use a movable hardstop to position an armature assembly rest angle and/or that are movable during triggering, e.g., by a pyrotechnic actuator. The movable hardstop may be more reliable than conventional designs that used a fixed hardstop. Devices including the mechanical hardstop can also be easier to manufacture, e.g., because they obviate the need for one or more fasteners. In some examples, devices using the features and techniques described herein may be more readily reusable.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1A is a perspective view of an electrical device, e.g., a fuse device, including a housing and electrical components, in accordance with aspects of this disclosure.

FIG. 1B is a perspective, cross-sectional view of portions of the electrical device of FIG. 1A, taken along section line B-B in FIG. 1A, in accordance with aspects of this disclosure.

FIG. 2A is a partial cross-sectional view of the electrical device of FIGS. 1A and 1B, showing a normal, closed state of the electrical device, in accordance with aspects of this disclosure.

FIG. 2B is a partial cross-sectional view corresponding to the view of FIG. 2A, showing a triggered, open state of the electrical device, in accordance with aspects of this disclosure.

### DETAILED DESCRIPTION

The subject technology overcomes many of the prior art problems associated with electrical devices. In brief summary, the subject technology provides improved electrical devices including a fuse design that may have improved performance compared to other conventional fuse devices. In examples, the electrical device may have two discrete operation states, including a first operating state and a second operating state. In the first operation state, the device is closed, such that current, e.g., from a high voltage source, may flow through the device. In the second operating state, the device is open, e.g., such that no current or voltage flows through the device.

In aspects of this disclosure, the electrical device can include an actuator that is configured to selectively cause the fuse to move from the closed operation state to the open operation state. In examples described, herein, the actuator is configured to selectively apply a force to a latch to reconfigure the latch from a retention state or configuration to a release state or configuration. In the retention state, the latch retains a shaft and/or a movable contact in a closed position, e.g., in which the movable contact contacts the fixed contact(s). In the release state, the latch disengages from the shaft, allowing the shaft/movable contact to move away from the fixed contact(s), thereby opening the device.

In examples, the actuator acts on the latch through a movable member. For example, the movable member may be a movable hardstop disposed in a housing of the electrical device. The movable hardstop may be configured to locate, position, and/or otherwise configure aspects of the device. For example, the movable hardstop may be configured to set an armature assembly rest angle. The movable hardstop can also be configured to move, e.g., via a force applied by the actuator, when the device is triggered to open. For example, the movable hardstop may be biased by a biasing member, such as one or more springs, in a direction away from the latch and/or toward the actuator. To open the device, the actuator can apply a force on the movable hardstop that overcomes the biasing force of the biasing member and moves the movable hardstop toward the latch. In examples of this disclosure, this movement of the movable hardstop causes the latch to move to the release position, thereby allowing the shaft to move to the open position.

In examples of this disclosure, the device can also include a plunger disposed between the movable member and the latch. Movement of the movable member just described will cause a corresponding movement of the plunger, and the plunger will contact (and move) the latch.

Some conventional devices may include a fixed hardstop upon which a force was applied to open the device. In these devices, the applied force causes the hardstop to deform or rupture, which causes a subsequent movement of the movable contact. However, because the conventional hardstop is fixed, the force required to open the device may be relatively large and/or the deformation of the fixed hardstop may consume large amounts of energy. Accordingly, these conventional devices may suffer from unreliability. Moreover, some of these conventional devices may be unusable in devices designed to passively trigger at relatively high current levels, e.g., because these devices have higher preload forces. For instance, the conventional devices may be unreliable and/or unusable in devices designed to passively trigger at or above 1500 Amps.

In contrast, in aspects of this disclosure the hardstop is movable against the biasing force of the biasing member. The biasing force is known, so the force required from the actuator can be reduced and/or more reliably achieved. Moreover, assembly of devices including the movable hardstop may be more readily or economically manufactured and/or assembled, e.g., because fasteners required to fix the hardstop in the conventional devices are eliminated. For example, by eliminating the fasteners present in conventional devices, the devices and configurations described herein may be manufactured using automated production processes.

The devices according to this disclosure may be used with both passive and/or active triggering. For example, the devices described herein can include one or more on-device components that are configured to generate a trigger signal that causes the actuator to open the device. In one non-limiting example, the devices described herein can include a reed switch disposed proximate the movable and/or fixed contacts. The reed switch may be configured to generate a signal corresponding to a magnetic field around the contacts. The strength of the field will vary based on the current flowing through the device, and thus the reed switch may be configured to generate a signal in response to a current at or above a threshold current value. In other examples, the devices described herein can include functionality to receive a signal from an off-device source, e.g., from an operator, a centralized computing system, or the like. For example, the remote source can transmit a signal to actively trigger the electrical device as an emergency or safety feature.

Without limitation, the devices and techniques described herein may provide improved electrical devices, which may be less complex, may be cheaper to manufacture and/or use, and/or that may have improved safety and/or result in improved system protection, when compared to similar conventional systems. For instance, as discussed above, the use of the movable hardstop as detailed herein may result in improved and/or more reliable triggering of the electrical device. In some examples, inclusion of the movable hardstop can also or alternatively be more readily manufactured and/or assembled than conventional devices.

While aspects of this disclosure may be particularly useful in certain applications, like fuses for use in high voltage electrical systems, the systems and techniques described herein may be useful with any electrical devices that incorporate movable contact members that facilitate selective opening/closing.

Aspects of the disclosure will now be explained in more detail with reference to the Figures.

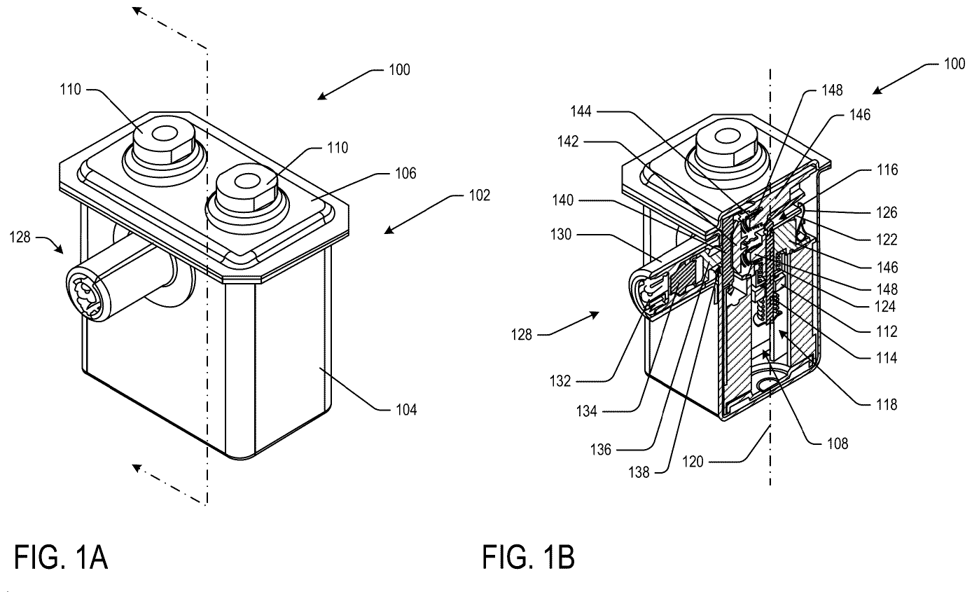

FIG. 1A is a perspective view of an electrical device 100, and FIG. 1B is a cross-sectional view of the electrical device 100 taken along the section line B-B in FIG. 1A. In examples of this disclosure, the electrical device 100 may be a fuse or switching device. The electrical device 100 may be a hybrid device, e.g., that includes a fuse or disconnect (such as a pyrotechnic disconnect) as well as contactor and/or switching features. As will be appreciated from this disclosure, aspects of this disclosure may be used with any device that incorporates a movable contact that can be selectively moved into contact with and spaced from one or more fixed contacts.

In the illustrated example, the electrical device 100 includes an electrical device housing 102. The housing 102 includes a housing base 104, e.g., a can, and a housing cover 106. In the example of FIG. 1, the housing cover 106 is configured to cooperate with the housing base 104. In examples, the housing base 104 and portions of the housing cover 106 may be metal parts, e.g., steel parts, welded to each other. The housing 102 defines, at least in part, a housing volume 108 (shown in FIG. 1B). In some examples, the housing volume 108 may be a hermetically-sealed volume. An electronegative gas may be contained in the housing volume 108. This hermetically sealed configuration can help mitigate or prevent electrical arcing between adjacent conductive elements, and in some embodiments, helps provide electrical isolation between conductive contacts. In some examples, the housing volume 108 can be under vacuum conditions and can be hermetically sealed using known means of generating hermetically sealed electrical devices.

In the illustrated example, the housing base 104 is substantially rectangular, having a bottom and four sidewalls defining a rectangular upper opening. The housing cover 106 may be a lid having a correspondingly rectangular shape that is coupled to the housing base 104 to occlude the upper opening, thereby forming the housing volume 108. Although the housing 102 is generally formed as a rectangular prism in the illustrated examples, in other examples the housing 102 may be otherwise shaped, including but not limited to being shaped like a cylinder, a cube, or otherwise.

The housing 102 is generally configured to support and/or retain features of the electrical device 100. For example, the view of FIG. 1A shows two fixed contacts 110 coupled to the housing cover 106. The fixed contacts 110 protrude partially from the housing cover 106. Although not visible in FIGS. 1A and 1B, the fixed contacts 110 extend partially into the housing volume 108, e.g. through the cover 106. The fixed contacts 110 are configured to electrically connect internal components of the electrical device 100 to external circuitry, for example, to an electrical system or device. For example, the fixed contacts 110 may be terminals configured to facilitate connection of first electrical leads (not shown) from a voltage source to second electrical leads (also not shown) associated with a load to be powered by the voltage source.

The electrical device 100 also includes a movable contact 112, visible in FIG. 1B. As detailed further herein, the movable contact 112 is movable between a first position contacting the fixed contacts 110 (e.g., a closed position) and a second position spaced from the fixed contacts 110 (e.g., an open position). The first position is shown in FIG. 1B, and the movable contact 112 may be moved downward (in the orientation of FIG. 1B) from the illustrated position to the second position.

In the illustrated example, the movable contact 112 is a generally elongate member that, in the first position illustrated in FIG. 1B, can simultaneously contact both of the fixed contacts 110. Accordingly, the movable contact 112 can selectively couple the two fixed contacts 110, to facilitate current flow between the fixed contacts 110 and thus through the electrical device 100.

In the electrical device 100, the movable contact 112 is coupled to a shaft 114. The shaft 114 is movable to facilitate selective opening and closing of the electrical device 100, e.g., by facilitating selective movement of the movable contact 112 into and out of contact with the fixed contacts 110. In the example, the shaft 114 extends from a first end 116 (an upper end in the orientation of FIG. 1B) to a second end 118 (a lower end in the orientation of FIG. 1B) along an axis 120. In the example of FIG. 1B, the movable contact 112 is coupled to the shaft 114 between the first end 116 and the second end 118.

As noted above, the shaft 114 and the movable contact 112 are movable to configure the electrical device 100 in an open configuration or a closed configuration. The closed configuration is illustrated. In this configuration, and as detailed further herein, a latch 122 contacts the shaft 114 proximate the first end 116 of the shaft. In this example, the latch 122 retains the shaft 114 against a biasing force associated with a return spring 124. The return spring 124 is a biasing member that is configured to bias the shaft 114 and the movable contact 112 away from the fixed contacts 110. That is, the return spring 124 biases the electrical device toward the open configuration. Thus, in the example of FIG. 1B, the latch 122 contacts the shaft 114 to retain the electrical device 100 in the closed configuration.

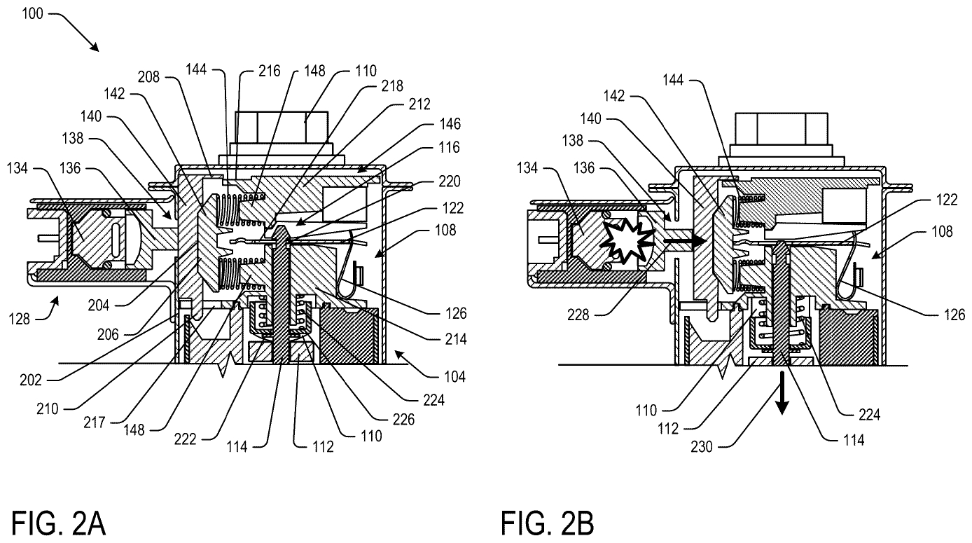

As detailed further herein, the latch 122 is movable between a retention position illustrated in FIG. 1B, e.g., the position engaging the shaft 114, and a release position spaced from the shaft 114 (illustrated in FIG. 2B and described further below). In the release position, the shaft 114 is no longer retained by the latch 122 against the biasing force of the return spring 124. Accordingly, when the latch 122 is configured in the release position, the return spring 124 biases the shaft 114 and the movable contact 112 into the open configuration, e.g., in which the movable contact 112 is spaced from the fixed contacts 110. As illustrated, the latch 122 is moved laterally, e.g., at a 90-degree angle, relative to the axis 120. In other examples, the latch 122 may be moved along a different path, including a linear path disposed at some angle other than a 90-degree angle. Without limitation, aspects of the electrical device 100 may be positioned to set the angle of alignment of the latch 122.

In the example, the latch 122 is biased into the retention position illustrated in FIG. 1B by a latch spring 126. The latch spring 126 is a biasing member that forces the latch 122 into contact with the shaft 114. Without limitation, the latch spring 126 may be formed from a strip of metal, such as a strip of spring steel, that is configured (e.g., bent or wound) to apply a biasing force to the latch 122. Other biasing members also will be appreciated by those having ordinary skill in the art with the benefit of this disclosure.

As just described, the latch 122 is positioned in the retention position to selectively retain the shaft 114 in the closed position, e.g., in which the movable contact 112 contacts the fixed contacts 110. Through the latch spring 126, the latch 122 is biased to the retention position. However, during an event, such as an overcurrent event, a short, or the like, it may be desirable to configure the electrical device 100 to inhibit the flow of electricity. To facilitate this opening of the electrical device 100, the latch 122 is forced against the force of the latch spring 126 to the release position (discussed further below with reference to FIG. 2B).

FIGS. 1A and 1B show an actuator 128 that is configured to selectively move the latch 122 into the release position. Although a specific example of the actuator 128 is illustrated, other actuators may be used.

In the illustrated example, the actuator 128 comprises a pyrotechnic actuator generally including an actuator housing 130 containing an electrical interface 132, a pyrotechnic charge 134, and a movable piston 136. The actuator housing 130 is illustrated as being substantially cylindrical, although this shape is not required. The electrical interface 132 may comprise a plug, port, or other feature through which signals, e.g., electrical signals, can be passed to the pyrotechnic charge 134, e.g., to selectively cause the pyrotechnic charge 134 to detonate. In some examples, the electrical interface 132 can be coupled to an electrical system with which the electrical device 100 is to be used, e.g., to receive information associated with an event that would require changing a state of the electrical device 100. In other examples, the electrical interface 132 may be coupled to a control system through which a user can interface with the actuator 128, e.g., to (manually or remotely) cause detonation of the pyrotechnic charge 134.

Detonation of the pyrotechnic charge 134 causes the movable piston 136 to move. Specifically, the force generated by the detonation of the pyrotechnic charge 134 will cause the movable piston 136 to move in the actuator housing 130 in a direction away from the pyrotechnic charge 134. In examples of this disclosure, the actuator 128 is configured to selectively force the latch 122 into the release position. More specifically, the movable piston 136 is configured to, upon detonation of the pyrotechnic charge 134, cause the latch 122 to move against the latch spring 126 to disengage the shaft 114. In examples of this disclosure, an opening 138 is formed through a sidewall of the housing base 104, and the actuator 128 is aligned with the opening. Accordingly, the actuator 128 is configured to apply a force to the latch 122 through the opening 138.

In examples of this disclosure, the force of the movable piston 136 is transferred to the latch 122 through one or more of a movable member 140 and a plunger 142 disposed in the volume 108. In examples, the movable member 140 is a hardstop that is configured to occlude the opening 138 opening formed in the sidewall of the housing 102. The movable member 140 is biased against the sidewall of the housing 102 to occlude the opening 138. In the example, the plunger 142 is disposed to contact a side of the movable member 140 opposite the sidewall 202 of the housing 102. In the example, the plunger 142 is biased against the movable member 140 by a biasing member 144. The biasing member 144 is illustrated as two compression springs that are configured to bias the plunger 142 away from the latch 122, e.g., in a direction of travel of the latch 122. The biasing of the plunger 142 correspondingly biases the movable member 140, e.g., the movable hardstop, against the inner surface of the sidewall of the housing 102.

In the illustrated example, the electrical device 100 also includes an inner housing 146 disposed in the volume 108. As illustrated, the inner housing 146 has an upper portion and a lower portion. The lower portion defines an opening through which the shaft 114 extends. The inner housing 146 may also support the biasing member 144. For example, the biasing member may extend between the inner housing 146 and the plunger 142, e.g., to bias the plunger 142 away from the inner housing 146. In the illustrated example, the inner housing 146 includes two protrusions 148, e.g. a first associated with the upper portion and a second associated with the lower portion. The springs comprising the biasing member 144 may be disposed on the protrusions 148, e.g., to locate the biasing member 144 and/or to retain the biasing member 144 relative to the inner housing 146. Although the biasing member 144 is illustrated as including two springs, in other examples more or fewer springs may be used and/or the biasing member can include other than compression springs. Any arrangement that biases the plunger 142 and/or the movable member 140 away from the latch 122 may be used. Additional details of the operation and configuration of the movable member 140, the plunger 142, the inner housing 146, and associated features are detailed further below with reference to FIGS. 2A and 2B.

During an event, such as a detected event or a user-initiated event, the actuator 128 may be controlled or triggered to open the electrical device 100. In the illustrated example, the event may cause a detonation of the pyrotechnic charge 134 that causes the pyrotechnic piston 136 to accelerate toward the movable member 140. The pyrotechnic piston 136 impacts the movable member 140, e.g., through the opening 138, and forces the movable member 140 (and the plunger 142) against the biasing force of the biasing member 144. This causes the biasing member 144 to compress, to a point at which the plunger 142 contacts the latch 122 and forces the latch against the biasing force of the latch spring 126. The force on the latch 122 by the plunger 142 is sufficient to overcome the biasing force of the latch spring 126, thus moving the latch to the release position discussed above.

Accordingly, in the design of FIGS. 1A and 1B, the movable member 140 and the plunger 142 are both movable within the housing volume 108 to selectively move the latch 122 to the release position. In some conventional examples, a hardstop may be provided that is fixed to the housing 102, e.g., the sidewall of the lower housing portion 104. In these examples, the actuator 128 may act on the fixed hardstop, which requires deformation of the hardstop to open the conventional device. For instance, in these conventional examples, the fixed hardstop would have to deform, e.g., fail or break, sufficiently to cause movement of the latch to the release position. Controlling this deformation has proven to be difficult and/or unreliable, such that these conventional devices may not open properly, thus creating unsafe conditions. Moreover, these types of conventional devices require fixing the hardstop relative to the device, e.g., using one or more fasteners. The inclusion of the fastener(s) increases assembly steps and/or assembly difficulty.

In contrast to the conventional devices just described, the present disclosure provides a movable hardstop, e.g., the movable member 140, that occludes the opening 138 and moves relative to the latch 122 against the biasing force of the biasing member 144. Attributes of the biasing member 144 will directly determine the force required to open the device 100, thus creating a more reliable device. Moreover, because the movable member 140 is not fastened to the electrical device 100, assembly is made simpler. For instance, and without limitation, during assembly, the cover 106 may be removed and the movable member 140 may be manually inserted between a sidewall of the lower housing 104 and the plunger 142, with the plunger 142 and/or the biasing member 144 retaining the movable member 140 in the proper position.

FIGS. 2A and 2B shows aspects of the electrical device 100 in more detail. Specifically, FIG. 2A is a cross-sectional view of the electrical device 100 in a closed state, e.g., in which the latch 122 is in the retention position and the shaft 114 and the movable contact 112 are in the closed position. Accordingly, FIG. 2A generally corresponds to the configuration shown in FIG. 1B. FIG. 2B is a cross-sectional view of the electrical device 100 in an open state, e.g., in which actuator has been triggered and causes the latch 122 to be moved to the release position. In FIGS. 2A and 2B, the same reference numerals used in FIGS. 1A and 1B designate the same components.

As noted, FIG. 2A shows the same configuration as FIG. 1B, discussed above. However, FIG. 2A shows more clearly the opening 138 formed in a sidewall 202 of the housing base 104. The actuator 128 is disposed proximate the opening 138, and the pyrotechnic piston 136 extends at least partially into the opening 138. The movable member 140, e.g., the hardstop, is generally pressed against an inner surface of the sidewall 202. In this example, the biasing member 144 biases the plunger 142 against the movable member 140 to press the movable member 140 against the sidewall 202. In examples, the piston 136 associated with the actuator 128 may contact the movable member 140 through the opening 138.

The movable member 140 and the plunger 142 may include one or more features to facilitate cooperation and/or location of those features. For example, the movable member 140 is illustrated as including a recess 204 that is configured to receive at least a portion 206 of the plunger 142. In the illustrated example, the portion 206 of the plunger 142 is an angled or tapered portion and the recess 204 of the movable member 140 is similarly angled. The angled surfaces may cooperate to locate the movable member 140 and the plunger relative to each other, e.g., in the axial direction. Although the recess 204 and the portion 206 are illustrated as tapered, any arrangement that causes the movable member 140 and the plunger 142 to be seated or otherwise cooperate may be used.

FIG. 2A also shows that the movable member 140 can include one or more additional locating features. For example, the movable member 140 can include an upper lateral protrusion 208 and/or a lower, axial protrusion 210. In examples of this disclosure, the protrusions 208, 210 may be configured to cooperate with, and move relative to, corresponding features on the inner housing 146.

FIG. 2A also shows the inner housing 146 in more detail. The inner housing 146 is generally fixed relative to the housing 102. As shown, and as noted above, the inner housing 146 can include an upper portion 212 and a lower portion 214. The portions may be formed as a single piece, e.g., a molded polymer piece, or the portions may be separate pieces fixed relative to each other (and relative to the housing 102). In examples, individual of the upper portion 212 and/or the lower portion 214 may also be formed of multiple pieces. Thus, without limitation, the inner housing 146 can be any number of structures or components that locate and/or support features of the electrical device 100, as described herein.

In the illustrated example, the upper portion 212 of the inner housing 146 includes an upper surface 216. The upper surface 216 is a generally horizontal surface. The upper surface 216 may be provided to cooperate with the upper lateral protrusion 208 of the movable member 140. Specifically, the upper lateral protrusion 208 may rest on the upper surface 216 of the inner housing 146, e.g., to locate the movable member in the axial direction. During movement of the movable member 140, as described further herein, the upper lateral protrusion 208 may slide along the upper surface 216.

The lower portion 214 of the inner housing 146 is illustrated as including a slotted opening 217. The slotted opening 217 may be configured to receive the lower axial protrusion 210 of the movable member 140. The lower axial protrusion 210 may be movable relative to the slotted opening 217, e.g., during triggering of the actuator 128, as detailed herein.

Although not illustrated in the Figures, the inner housing 146 can also be configured to support one or more passive triggering components, e.g., reed switches or the like. Because the inner housing 146 is fixed relative to the housing 102, the passive triggering components can provide consistent electromagnetic actuation in the passive over-current response. However, in an active trigger response, the movable member 140 reduces the energy needed to move the latch 122, allowing for both passive and active triggering for high current levels, such as currents at or above 1500 Amperes.

FIG. 2A also shows the posts or protrusions 148 on which the biasing members 144 are disposed. The protrusions 148 are spaced relative to each other by a distance, e.g., in the axial direction, to at least partially define an area in which the latch 122 extends. As better seen in FIG. 2A, the latch 122 is an elongate member extending from a first end generally disposed proximate the plunger 142 to a second end contacting the latch spring 126. In the illustrated example, the second end of the latch 122 may be forked or otherwise define a slot configured to receive a portion of the latch spring 126. The latch 122 also includes a slotted opening 218. The slotted opening 218 is configured to receive and provide clearance for the first end 116 of the shaft 114.

In the illustrated example, the end of the slotted opening 218 closest to the latch spring 126 forms an edge that contacts the shaft 114, e.g., to retain the shaft 114 in the illustrated position. In this example, the shaft 114 includes an undercut 220, generally formed as a narrow or necked region proximate the first end 116 of the shaft 114. As shown, the latch spring 126 biases the latch 122 (to the left in the orientation of FIG. 2A) such that the latch 122 is disposed in the undercut 220. Thus, the latch 122 prevents downward motion of the shaft 114, as discussed herein.

In this configuration, the latch 122 holds the shaft 114 against a biasing force that would force the shaft axially (downward in FIG. 2A). As shown in the example of FIG. 2A, the shaft 114 also includes a flange 222 formed as a lateral protrusion at a position along the length of the shaft 114. A return spring 224 is configured to apply an axial force to the shaft 114 at the flange 222. In the illustrated example, the return spring 224 is retained in a return spring retainer 226, and the return spring retainer 226 is disposed on the flange 222. In this example, the lower portion 214 of the inner housing 146 includes an opening through which the shaft 114 extends, and the return spring 224 is disposed to bias the shaft 114 away from the lower portion 214 of the inner housing 146.

From the foregoing description, in the closed configuration shown FIG. 2A, the shaft 114 is held against the force of the return spring 224 to maintain the movable contact 112 in contact with the fixed contacts 110 (a portion of one of which is visible in FIG. 2A). The latch 122 retains the shaft 114 in this closed position at an interface of the slotted opening 218 of the latch and the undercut 220 of the shaft 114. The latch 122 is biased to, and maintained in, this retention position by the latch spring 126. Also in the closed configuration, the plunger 142 and the movable member 140 are biased away from the latch 122, e.g., by the biasing member 144, such that the movable member 140 contacts the sidewall 202.

FIG. 2B shows the electrical device 100 as it transitions from the closed state of FIG. 2A to an open state. In the example, the pyrotechnic charge 134 is detonated. For example, the pyrotechnic charge 134 may be triggered actively or passively. The pyrotechnic charge 134 may be triggered actively by a user, e.g., regardless of a current state of the system. For example, the active trigger may be a remote safety disconnect. In other examples, the pyrotechnic charge 134 may be triggered passively, e.g., in response to a current level in the system being met or exceeded.

When the pyrotechnic charge 134 is denotated, the pyrotechnic piston 136 is forced away from the pyrotechnic charge 134, e.g., toward the volume 108 defined by the housing 104. The pyrotechnic piston 136 extends through the opening 138 and applies a force to the movable member 140. The force on the movable member 140 causes the plunger 142 to push against, e.g., compress, the biasing member 144. This movement is generally shown by the arrow 228.

As the movable member 140 and the plunger 142 move in the direction of the arrow 228 under the force of the detonation, the plunger 142 contacts and correspondingly moves the latch 122. Specifically, the latch is moved in the direction of the arrow 228 such that the slotted opening 218 disengages from the undercut 220. As noted above, the slotted opening 218 is sized to provide a clearance fit with the shaft 114. Accordingly, the shaft 114 is no longer retained against the biasing force of the return spring 224. As illustrated by the arrow 230, the return spring 224 causes the shaft 114 to move (downward in the FIG.) to disengage the movable contact 112 from the fixed contacts 110, thereby opening the electrical device 100. In examples, the force applied on the shaft 114 by the biasing member 224, a weight of the shaft 114, a weight of the biasing member 224, and/or the weight of other components associated with the shaft 114 may be sufficient to prevent the shaft 114 from moving axially upward, e.g., to prevent the movable contact 112 from moving into contact with the fixed contacts 110 to “re-close” the electrical device 100.

In some examples, after the detonation of the pyrotechnic charge 134 and the opening of the electrical device 100 as just described, the biasing member 144 may return the movable member 140 and the plunger 142 to the position shown in FIG. 2A, e.g., in which the movable member 140 is pressed against the sidewall 202. That is, once the energy associated with the detonation dissipates, the biasing member 144 will act on the plunger 142 and the movable member 140 to return those features to their positions associated with the closed orientation. In addition, the latch spring 126 may bias the latch 122 in the direction opposite the arrow 228.

As noted above, in examples of this disclosure the shaft 114 may be retained in the open position by the biasing member 224. The shaft 114 may also or alternatively be retained in the open position by one or more additional features. For instance, because the shaft 114 is moved out of the path of travel of the latch 122, e.g., the shaft 114 may be below the latch 122, the latch 122 may move further (to the left in the illustration) than the position shown in FIG. 2A. Accordingly, the slotted opening 218 will no longer be axially aligned with the shaft 114 and the latch 122 may effectively function as a cover or stop that inhibits or prevents the shaft 114 from moving axially upward. Accordingly, by preventing upward movement of the shaft 114, the latch 122 may maintain a distance between the movable contact 112 and the fixed contacts 110. Stated differently, the latch spring 126 may configure the latch 122 in a position to lock out the electrical device 100 in some non-limiting examples. In other non-limiting examples, the electrical device 100 may further include a catch, e.g., disposed within the housing volume 108, configured to retain the movable contact 112 in a position spaced from the fixed contacts 110.

In some examples, after the opening of the electrical device 100 as just described, the electrical device 100 can be reused. For instance, and without limitation, the actuator 128 or portions thereof, may be replaced, the latch 122 can be manually repositioned to axially align the slotted opening 218 with the shaft 114 and the shaft 114 can be manually moved against the return spring 224 to the closed position illustrated in FIG. 2A. This may be different from conventional devices in which the movable member 140 is not included, but instead a fixed hardstop, which is destroyed during detonation, must be replaced entirely.

Although in the example described herein the actuator 128 is a pyrotechnic actuator, this is not required. The pyrotechnic actuator may be desirable for the relatively large force it provides relatively quickly, but other actuator types may also be used. For example, and without limitation, the actuator can be a mechanical, electromechanical, and/or any other actuator that can selectively apply a force against the movable member 140 to move in accordance with the foregoing description.

Other modifications to the foregoing description also are anticipated. For example, although both the movable member 140 and the plunger 142 are illustrated, in other examples a single component may be used. For example, if the plunger 142 is omitted, the biasing member 144 may act directly on the movable member 140. In contrast, if the movable member 140 is omitted, the plunger 142 may be pressed against the sidewall 202 and/or the actuator may act directly on the plunger 142, e.g., through the opening 138.

Moreover, although the electrical device 100 is illustrated and described as a normally closed fuse device, the features of this disclosure can be used with other configurations and/or devices. For example, the movable member 140 of this disclosure can be used in a normally-open device. In such a device, the movable contact 112 may be biased toward the fixed contacts 110 (e.g., in a biasing direction opposite that of the return spring), and the latch may be configured to retain the shaft 114 at a position that spaces the movable contact 112 from the fixed contacts 110. Accordingly, triggering this normally-open device will cause the latch 122 to release the shaft 114 such that the shaft 114 is driven by the biasing force in a direction that causes the movable contact 112 to contact the fixed contacts 110.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A switching device comprising:
a housing defining a volume;
one or more fixed contacts disposed at least partially in the volume defined by the housing;
a movable contact disposed in the volume;
a shaft coupled to the movable contact and movable between a first position that configures the switching device in a closed configuration in which the movable contact contacts the one or more fixed contacts and a second position that configures the switching device in an open configuration in which the movable contact is spaced from the one or more fixed contacts;
a spring applying a biasing force that biases the shaft toward the second position;
a latch movable between a retention position retaining the shaft in the first position against the biasing force and a release position in which the shaft is movable by the biasing force;
a first biasing member biasing the latch into the retention position;
a movable member;
a second biasing member biasing the movable member away from the latch; and
an actuator configured to selectively force the movable member against the second biasing member to cause the latch to move, against the first biasing member, to the release position.

2. The switching device of claim 1, further comprising:
a plunger disposed between the movable member and the latch,
wherein the second biasing member biases the plunger away from the latch and into contact with the movable member.

3. The switching device of claim 2, wherein:
the movable member comprises a recess configured to retain at least a portion of the plunger.

4. The switching device of claim 1, wherein the second biasing member comprises a plurality of compression springs.

5. The switching device of claim 1, wherein the second biasing member biases the movable member against an inner surface of the housing.

6. The switching device of claim 5, wherein:
the housing includes an opening;
the second biasing member biases the movable member against an inner surface of the housing to occlude the opening; and
the actuator is disposed at least partially outside the housing at a position to apply a force to the movable member through the opening.

7. The switching device of claim 1, wherein:
the shaft is moved between the first position and the second position in an axial direction; and
the latch moves between the retention position and the release position at an angle relative to the axial direction.

8. The switching device of claim 7, wherein the latch moves between the retention position and the release position at an angle that is substantially 90-degrees relative to the axial direction.

9. The switching device of claim 7, wherein:
the shaft includes a radial undercut; and
the latch engages the radial undercut in the retention position.

10. The switching device of claim 1, wherein:
the actuator is a pyrotechnic actuator including a pyrotechnic charge and a movable piston, and
detonation of the pyrotechnic charge causes the movable piston to contact the movable member to force the movable member against the second biasing member.

11. An electrical device comprising:
a housing defining a volume;
fixed contacts coupled to the housing and extending into the volume,
a shaft,
a movable contact coupled to the shaft,
a latch configurable between a retention position in which the latch contacts the shaft to retain the shaft in a closed position in which the movable contact contacts the fixed contacts and a release position in which the latch is spaced from the shaft;
a movable member biased away from the latch; and
an actuator configured to selectively force the movable member toward the latch and cause the latch to move to the release position.

12. The electrical device of claim 11, further comprising:
a plunger disposed between the movable member and the latch, and
a biasing member biasing the plunger away from the latch and into contact with the movable member.

13. The electrical device of claim 12, further comprising:
an interior housing disposed within the volume, the interior housing defining a shaft opening into which the shaft at least partially extends,
wherein the biasing member extends between the interior housing and the plunger.

14. The electrical device of claim 13, wherein the interior housing comprises a post and the biasing member is disposed on the post.

15. The electrical device of claim 12, wherein:
the movable member comprises a recess configured to retain at least a portion of the plunger.

16. The electrical device of claim 12, wherein the biasing member comprises a plurality of compression springs biasing the plunger into the movable member.

17. The electrical device of claim 12, wherein the biasing member biases the movable member against an inner surface of the housing.

18. The electrical device of claim 12, wherein:
the housing includes an opening;
the biasing member biases the movable member against an inner surface of the housing to occlude the opening; and
the actuator is disposed at least partially outside the housing at a position to apply a force through the opening to move the movable member.

19. The electrical device of claim 18, wherein:
the shaft is moved between a closed position and an open position in an axial direction; and
the latch moves between the retaining position and the release position at an angle relative to the axial direction.

20. The electrical device of claim 11, wherein the actuator is a pyrotechnic actuator.
